(19) United States
(12) Patent Application Publication
(10) Pub. No.: US 2006/0103984 A1
(43) Pub. Date: May 18, 2006

(54) Flexible printed circuit and hard disk drive with the same

(75) Inventors: Sang-chul Shin, Osan-si (KR); Jeong-seon Kim, Suwon-si (KR); Severinets Georgiy, Suwon-si (KR); Jun-voung Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (JP)

(21) Appl. No.: 11/260,297

(22) Filed: Oct. 28, 2005

(30) Foreign Application Priority Data
Oct. 29, 2004 (KR) 10-2004-0087179

(51) Int. Cl. G11B 5/48; G11B 21/16

(52) U.S. Cl. 360/245.9

(57) ABSTRACT

Provided is a flexible printed circuit including a circuit layer with a desired circuit formed thereon, a base layer supporting the circuit layer, a conductive metal layer positioned on at least one side of the base layer, and an insulation film interposed between the base layer and the conductive metal layer. A hole is formed on the circuit layer and the base layer through punching work, and the insulation film covers one end of the hole.

### CROSS-REFERENCE TO RELATED APPLICATIONS

This application claims the benefit of Korean Patent Application No. 10-2004-0087179, filed Oct. 29, 2004, in the Korean Intellectual Property Office, the disclosure of which is incorporated herein by reference.

### BACKGROUND OF THE INVENTION

1. Field of the Invention

The present invention relates to a flexible printed circuit for a hard disk drive, and more particularly, to a flexible printed circuit capable of preventing short circuit and air leakage between a circuit layer and a conductive metal layer. Also, the present invention relates to a hard disk drive with the flexible printed circuit.

2. Description of the Related Art

In information storages for a computer, a hard disk drive (HDD) reads data from a disk or writes data on the disk by use of a reading/writing head.

Such a hard disk drive includes a printed circuit board (PCB) with a circuit formed thereon to drive an actuator to which the reading/writing head is mounted. Since the actuator is rotated in a certain range when reading or writing, the printed circuit board connected to the actuator has flexibility so as to prevent movement of the actuator from being interfered and thus maintain stable contact between the printed circuit board and the actuator. The printed circuit board having flexibility is referred to as a flexible printed circuit (FPC).

One example of a conventional flexible printed circuit is disclosed in Japanese Patent Unexamined Publication No. 1996-153940.

When the conventional flexible printed circuit carries out writing or reading operation, the flexible printed circuit comes into contact with a certain portion of a hard disk drive. Static electricity is produced at the contacted portion, which has a bad influence upon the operation of the hard disk drive. Accordingly, in order to reduce production of the static electricity, the conventional flexible printed circuit includes a metal layer being in contact with a base layer.

Also, the flexible printed circuit includes a circuit layer. In order to reduce manufacturing costs of the flexible printed circuit and simplify a process thereof, after the circuit layer is formed in a structure generally connected to circuits, the circuit layer is processed through punching work to separate each circuit.

Burrs may be created on the circuit of the circuit layer when carrying out punching work. As a result, the circuit layer is connected to the metal layer through the burrs, and this may cause a short circuit. The short circuit may result in a defect or malfunction of the hard disk drive.

In addition, if a seal between the metal layer and the base layer is completed in the conventional flexible printed circuit board, external air may flow in the hard disk drive. Since Inflow of the external air is not filtered, fine particulates contained in the air flow into the hard disk drive. The particulates entered into the hard disk drive are attached to a disk and a writing/reading head, or float in an internal space of the hard disk drive. Thermal asperity results from the particulates. This thermal asperity causes air or gas particulates interposed between the writing/reading head and the disk to rub against the head and disk when the head writes or reads data from or on the disk. This causes the temperature of the head and disk to abruptly increase to several hundreds Celsius in a short time. The increased temperature of the head and disk may change the physical property of the head and disk, and cause a scratch on a surface of the disk, which deteriorates the performance of the hard disk drive.

### SUMMARY OF THE INVENTION

Additional aspects and/or advantages of the invention will be set forth in part in the description which follows and, in part, will be apparent from the description, or may be learned by practice of the invention.

Accordingly, it is an aspect of the present invention to provide a flexible printed circuit having an insulation film for preventing a short circuit between a circuit layer and a conductive metal layer, and air leakage through a punching hole, and also, provide a hard disk drive with the flexible printed circuit.

According to one aspect of the present invention, there is provided a flexible printed circuit including a circuit layer with a desired circuit formed thereon, a base layer supporting the circuit layer, a conductive metal layer positioned on at least one side of the base layer, and an insulation film interposed between the base layer and the conductive metal layer, in which a hole is formed on the circuit layer and the base layer through punching work, and the insulation film covers one end of the hole.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view of a hard disk drive according to the present invention;

FIG. 2 is an exploded view of a circle portion indicated by A in FIG. 1; and

FIG. 3 is a cross-sectional view of a flexible printed circuit taken along a line B-B in FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Reference will now be made in detail to a flexible printed circuit according to an embodiment of the present invention and a hard disk drive with the flexible printed circuit with reference to the accompanying drawings in which like parts or elements are denoted by like reference numbers throughout the several views of the drawings.

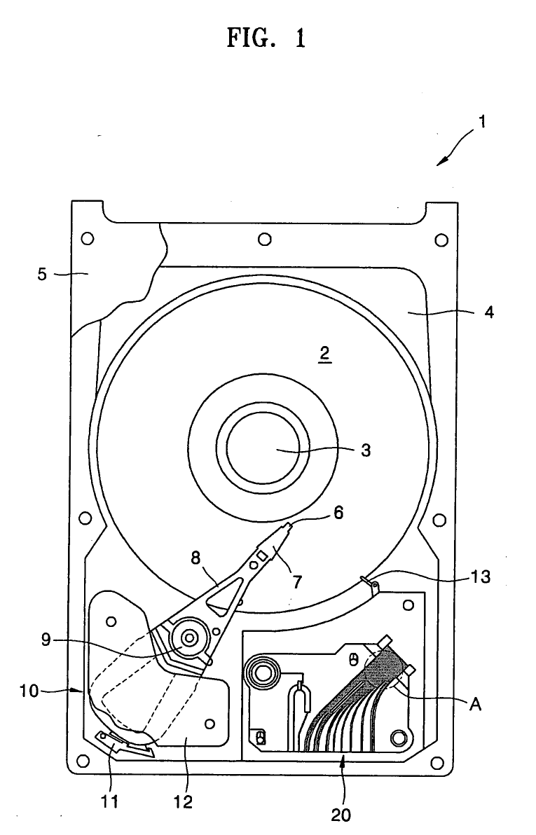

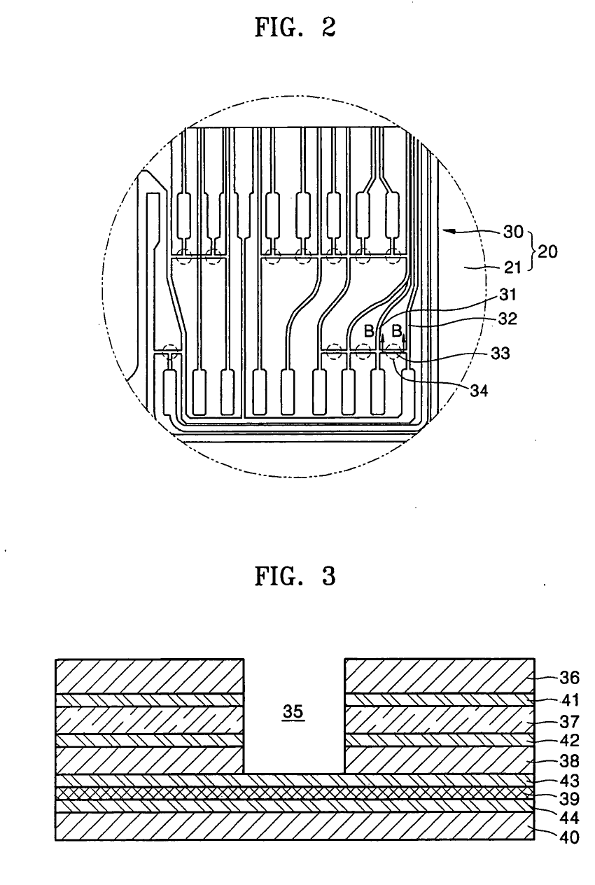

FIG. 1 is a plan view of a hard disk drive according to the present invention, and FIG. 2 is an exploded view of the circled portion indicated by A in FIG. 1.

Referring to FIGS. 1 and 2, a hard disk drive 1 includes at least one magnetic disk 2 turned by a spindle motor 3. The spindle motor 3 may be mounted to a base member 4 of the hard disk drive 1. The hard disk drive 1 may further include a cover member 5 enclosing the disk 2.

Also, the disk drive 1 includes a plurality of heads 6 positioned adjacent to the disk 2. Each head 6 may have a separate writing element (not shown) and reading element (not shown). The head 6 is mounted to a flexure arm 7 as a head gimbal assembly (HGA). The flexure arm 7 is coupled to an actuator arm 8 that is pivotally installed to a base member 4 by means of a bearing assembly 9. A voice coil 10 forms a voice coil motor (VCM) together with a magnetic assembly 12. When an electric current is applied to the voice coil 10, torque is generated around the voice coil 10 to rotate the actuator arm 8. The head 6 moves across the surface of the disk 2 by the generated torque.

The hard disk drive 1 may be provided with a ramp 13 positioned adjacent to an outer edge of the disk 2. When the hard disk drive 1 does not write or read information from or on the disk 2, the head 6 moves and parks onto the ramp 13. Also, the hard disk drive 1 may be provided with a latch 11 to be latched onto a lip portion of the actuator arm 8 to lock the actuator arm 8.

Also, the hard disk drive 1 may include a printed circuit board assembly 20 having a flexible printed circuit 30 and a bracket 21 coupled to the flexible printed circuit 30. Preferably, the bracket 21 is in contact with a conductive metal layer of the flexible printed circuit 30 which will be described hereinafter. The flexible printed circuit 30 is connected to the voice coil 10, the head 6, and the spindle motor 3.

The flexible printed circuit 30 according to the present invention is provided with desired circuits, and a residual circuit between the desired circuits after implementing a process of forming the circuit. The circuit will be described with reference to a first circuit 31, a second circuit 32, and a residual circuit 33 shown in FIG. 2.

When the circuit layer is formed on the flexible printed circuit 30, a circuit forming process is implemented on the entire circuit layer so as to reduce the manufacturing costs, simplify the manufacturing process, and secure a uniform quality and standard between manufactured circuits. The circuit forming process is generally implemented through etching. The circuit forming process is implemented to form the first circuit 31, the second circuit 32, and the residual circuit 33. The first and second circuits 31 and 32 are adapted to carry out a designated function, but the residual circuit 33 is produced due to a characteristic of the circuit forming process on the entire circuit layer. The residual circuit 33 may cause a short circuit between the first circuit 31 and the second circuit 32, resulting in the first and second circuits 31 and 32 to not function properly. Therefore, the residual circuit 33 should be removed.

The residual circuit 33 may be removed through an etching or mechanical punching process. The residual circuit 33 is generally removed through the mechanical punching process so as to reduce the manufacturing costs of the flexible printed circuit and to simplify the process thereof. A mechanical punching line 34 is denoted by a dotted line in FIG. 2. After implementing the punching work along the punching line 34, the conductive metal layer and an insulation film are adhered to the flexible printed circuit 30, which will be described with reference to FIG. 3.

FIG. 3 is a cross-sectional view of a flexible printed circuit 30 taken along a line B-B in FIG. 2.

Referring to FIG. 3, the flexible printed circuit 30 includes a circuit layer 37 having a desired circuit formed thereon, a base layer 38 supporting the circuit layer 37, and a cover layer 36 covering the circuit layer 37. The base layer 38 is provided on one surface thereof with an insulation film 39 and a conductive metal layer 40. Adhesive layers 41, 42, 43 and 44 are interposed between the circuit layer 37, the base layer 38, the cover layer 36, the insulation film 39, and the conductive metal layer 40, respectively, to firmly adhere their facing layers.

The circuit layer 37 is interposed between the cover layer 36 and the base layer 38, and includes various circuits to implement the function of the hard disk drive 1 according to the present invention.

The base layer 38 is interposed between the circuit layer 37 and the insulation film 39 to support the circuit layer. The cover layer 36 covers the circuit layer 37 to protect the circuit layer 37.

After the circuit layer 37, the base layer 38, and the cover layer 36 are adhered to each other by means of the adhesive layers 41 and 42, the layers are substantially punched along the punching line 34. After implementing the punching work, a punching hole 35 is formed through the circuit layer 37, the base layer 38, and the cover layer 36, which are adhered to each other by the adhesive layers 41 and 42. The formation of the punching hole 35 removes the residual layer 33 that exists between the first and second circuits 31 and 32, so that the first and second circuits 31 and 32 can independently and respectively function. Upon punching, a burr may be produced on the circuit layer 37 along the punching line 34. The burr may also come into contact with the conductive metal layer 40 to cause the short circuit between the circuit layer 37 and the conductive metal layer 40. The flexible printed circuit 30 according to the present invention includes an insulation film 39 to prevent the short circuit that results from the burr, which will be described hereinafter.

The conductive metal layer 40 is adapted to reduce electronic magnetic interference (EMI), and the conductive metal layer 40 easily assembles to the flexible printed circuit 30 and the bracket 21 (FIG. 2) without deforming the flexible printed circuit 30 and the bracket 21. Preferably, the conductive metal layer 40 is made of aluminum, iron, or an alloy of aluminum and iron.

The insulation film 39 has one side adjacent to the base layer 38 and the other side adjacent to the conductive metal layer 40, so as to prevent the burr extended from the circuit layer 37 from being in contact with the conductive metal layer 40. Accordingly, it can prevent the short circuit from occurring between the circuit layer 37 and the conductive metal layer 40 through the burr.

The insulation film 39 is adhered to the base layer 38 and the conductive metal layer 40 through the adhesive layers 43 and 44, and is adapted to cover the punching hole 35, thereby isolating the punching hole 35 from the exterior. Therefore, it is possible to isolate the external air from flowing in the hard disk drive 1 (FIG. 1), which prevents thermal asperity due to particulates contained in the inflow air.

The insulation film 39 may be made of polyethylene terephthalate (PET). PET has high heat resistance and rigidity, and if it is exposed to a high temperature for a long time, its rigidity is hardly changed. Alternatively, the insulation film 39 may be made of polyimide that has good durability against high temperature and friction. Preferably, the insulation film 39 is made of material suitable for a temperature characteristic depending upon a driving circumference of the hard disk drive 1 and baking of the flexible printed circuit 30. Specifically, the insulation film 39 of polyethylene terephthalate may be utilized at a temperature of below 100° C., while the insulation film 39 of polyimide may be utilized at a temperature of above 250° C. In general, the flexible printed circuit 30 is baked at a high temperature of above 250° C., and the hard disk drive 1 is subject to about 80° C. generated at the operation of the hard disk drive. Preferably, the insulation film 39 of polyimide is utilized.

The adhesive layers 41, 42, 43 and 44 are adapted to adhere the cover layer 36 and the circuit layer 37, the circuit layer 37 and the base layer 38, the base layer 38 and the insulation film 39, and the insulation film 39 and the conductive metal layer 40, respectively. In particular, the adhesive layers 43 and 44 adhering the base layer 38, the insulation film 39 and the conductive metal layer 40 function to isolate the punching hole 35 from the exterior, so as to doubly seal the punching hole 35 with the insulation film 39.

The adhesive layers 41, 42, 43 and 44 are made of material suitable for a temperature characteristic depending upon the driving circumstances of the hard disk drive 1 (FIG. 1) and the baking of the flexible printed circuit 30, as the insulation film 39. Specifically, the adhesive layers 41, 42, 43 and 44 are generally made of acrylic material to be utilized at a temperature of about 120° C. Since the flexible printed circuit 30 is baked at a high temperature of above 250° C., the adhesive layers are preferably made of material having good durability against the high temperature. Therefore, the adhesive layers 41, 42, 43 and 44 may be made of silicon material suitable for a range of about 300° C.

Alternatively, without utilizing the adhesive layers 43 and 44 provided on the upper surface and the bottom surface of the insulation film 39, the insulation film 39 may be heated at a certain temperature to soften both sides of the insulation film and thereby to have a self-adhesive property, so that the base layer 38 may be directly adhered to the conductive metal layer 40.

With the above description, according to the flexible printed circuit of the present invention and the hard disk drive with the flexible printed circuit, the insulation film is interposed between the base layer and the conductive metal layer to prevent the short circuit between the conductive metal layer and the circuit layer.

Also, the punching hole is isolated by the insulation film from the exterior to prevent the air leakage.

In addition, the adhesive layers are provided at both sides of the insulation film to further effectively protect the short circuit and the air leakage between the conductive metal layer and the circuit layer.

While the present invention has been particularly shown and described with reference to exemplary embodiments depicted in the drawings, it will be understood by those of ordinary skill in the art that various changes and modifications in form and details may be made therein without departing from the spirit and scope of the present invention. Therefore, the true spirit and scope for protection of the present invention is defined by the following claims.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A flexible printed circuit comprising:
a circuit layer with desired circuits formed thereon;
a base layer supporting the circuit layer;
a conductive metal layer positioned on at least one side of the base layer; and
an insulation film interposed between the base layer and the conductive metal layer,
in which a hole is formed on the circuit layer and the base layer through punching work, and the insulation film covers one end of the hole.

2. The flexible printed circuit of claim 1, wherein the insulation film is made of polyimide.

3. The flexible printed circuit of claim 1, wherein the conductive metal layer is made of one of aluminum and iron.

4. The flexible printed circuit of claim 1, wherein the conductive metal layer is made of an alloy of aluminum and iron.

5. A hard disk drive including an actuator with a writing/reading head installed to a front end thereof, a flexible printed circuit for driving the actuator, and a bracket connected to the flexible printed circuit, the flexible printed circuit comprising:
a circuit layer with a desired circuit formed thereon;
a base layer supporting the circuit layer;
a conductive metal layer positioned on at least one side of the base layer; and
an insulation film interposed between the base layer and the conductive metal layer,
in which a hole is formed through the circuit layer and the base layer through punching work, and the insulation film covers one end of the hole.

6. The hard disk drive of claim 5, wherein the conductive metal layer is in contact with the bracket.

7. The hard disk drive of claim 5, wherein the insulation film includes one side adhered to the conductive metal layer and the other side adhered to the base layer.

8. The hard disk drive of claim 5, wherein the insulation film is made of polyimide.

9. The hard disk drive of claim 5, wherein the conductive metal layer is made of one of aluminum and iron.

10. The hard disk drive of claim 5, wherein the conductive metal layer is made of an alloy of aluminum and iron.

11. A flexible printed circuit comprising:
a circuit layer with circuits formed thereon;
a base layer supporting the circuit layer;
a conductive metal layer positioned on at least one side of the base layer, and
wherein an the insulation film is interposed between the base layer and the conductive metal layer to prevent a short circuit between the conductive metal layer and a circuit layer.

12. The flexible printed circuit of claim 11, wherein the insulation film is adhered to the base layer and the conductive metal layer through an adhesive layer, said adhesive layer being adapted to isolate a punching hole from the exterior in order to prevent thermal asperity due to particulates contained in the inflow air.

13. The flexible printed circuit of claim 12, wherein the punching hole removes a residual circuit that causes a short circuit between the conductive metal layer and the circuit layer.
